(19) United States
(12) Patent Application Publication
(10) Pub. No.: US 2020/0172226 A1
(43) Pub. Date: Jun. 4, 2020

(54) ARM AND UNMANNED AERIAL VEHICLE

(71) Applicant: AUTEL ROBOTICS CO., LTD., Shenzhen (CN)

(72) Inventor: Feng NI, Shenzhen (CN)

(21) Appl. No.: 16/781,412

(22) Filed: Feb. 4, 2020

Related U.S. Application Data
(63) Continuation of application No. PCT/CN2018/083757, filed on Apr. 19, 2018.

(30) Foreign Application Priority Data
Aug. 4, 2017 (CN) 201710661948.5

(51) Int. Cl. B64C 1/30; B64C 1/06; B64C 25/10; B64C 39/02; B64C 27/08

(52) U.S. Cl. CPC B64C 1/30; B64C 1/063; B64C 25/10; B64C 2201/20; B64C 27/08; B64C 2201/024; B64C 39/024

(57) ABSTRACT

Embodiments of the present invention disclose an arm and an unmanned aerial vehicle (UAV). The arm is mounted on a movable object and is in contact with an outline of the movable object after being folded. The UAV includes a vehicle body, the arm connected to the vehicle body and a power device disposed on the arm. The arm is in contact with an outline of the vehicle body after being folded. According to the technical solutions, the arm provided in the embodiments of the present invention can be in contact with the outline of the movable object after being folded, so that the structure of the movable object to which the arm is applied is more compact.

This application is a continuation application of International Application No. PCT/CN2018/083757, filed on Apr. 19, 2018, which claims priority of Chinese Patent Application No. 201710661948.5, filed on Aug. 4, 2017, which is incorporated herein by reference in its entirely.

### BACKGROUND

### Technical Field

The present invention relates to the field of unmanned aerial vehicle (UAV) technologies, and in particular, to an arm and a UAV having the arm.

### Related Art

An unmanned aerial vehicle (UAV) is a type of new concept equipment in rapid development, and has advantages of high flexibility, quick response, pilotless driving and low operation requirements. The UAV can implement functions of real-time video transmission and high-risk area detection by carrying a plurality of types of sensors or camera devices, and is a powerful supplement of satellite remote sensing and conventional aerial remote sensing. Currently, the application range of the UAV has been expanded to three fields: military, scientific research and civil use, and in particular, to fields such as power communication, meteorology, agriculture, ocean, exploration, photography, disaster prevention and reduction, crop yield estimation, drug enforcement and smuggling suppression, border patrol, public security and anti-terrorism.

Currently, a rotor UAV is generally not easy to carry. Based on this, although some UAVs can be folded and received in a certain space, there still exist problems that the folding structure is excessively complex and not compact enough.

### SUMMARY

Embodiments of the present invention provide an arm and an unmanned aerial vehicle (UAV) having the arm, so as to resolve the problems that the folding structure of an existing foldable UAV is excessively complex and not compact enough.

To resolve the foregoing technical problems, the present invention adopts a technical solution: An arm mounted on a movable object is provided, where the arm is in contact with an outline of the movable object after being folded.

In some embodiments, the arm includes a main arm and an auxiliary arm connected to the main arm.

In some embodiments, the main arm includes at least two connecting rods, one end of at least one of the at least two connecting rods being connected to the auxiliary arm.

In some embodiments, the main arm includes a first connecting rod and a third connecting rod connected to one end of the first connecting rod, and the auxiliary arm is connected to a tail end of the third connecting rod.

In some embodiments, the main arm further includes a second connecting rod, one end of the second connecting rod being connected to one end of the first connecting rod, and the other end being connected to one end of the third connecting rod.

In some embodiments, the second connecting rod is hinged to one end of the first connecting rod.

In some embodiments, the third connecting rod is hinged to the second connecting rod.

In some embodiments, an included angle α between the first connecting rod and the second connecting rod is an obtuse angle, and an included angle β between the second connecting rod and the third connecting rod is an obtuse angle.

In some embodiments, the auxiliary arm is hinged to the tail end of the third connecting rod.

In some embodiments, a middle portion of the auxiliary arm is hinged to the tail end of the third connecting rod.

In some embodiments, the arm is a flexible member having certain strength, and the flexible member may change its shape according to the outline of the movable object, so that the arm is in contact with the outline of the movable object after being folded.

In some embodiments, the movable object is a UAV.

To resolve the foregoing technical problems, the present invention adopts another technical solution: A UAV is provided, including a vehicle body, an arm connected to the vehicle body and a power device disposed on the arm, where the arm is in contact with an outline of the vehicle body after being folded.

In some embodiments, the arm is the arm described above.

In some embodiments, the vehicle body is provided with an accommodating groove corresponding to the arm, and the arm is accommodated in the accommodating groove after being folded.

In some embodiments, there are at least two arms, and each arm includes a main arm and an auxiliary arm connected to the main arm. The power device is disposed on the auxiliary arm, and after the two arms are folded, the power devices located on the two auxiliary arms respectively are disposed in directions away from each other.

In some embodiments, the auxiliary arm is further provided with a landing gear.

In some embodiments, the landing gear is hinged to the auxiliary arm. There is a specific distance between the at least two auxiliary arms after the at least two arms are folded, and the landing gear is folded and stored between the at least two auxiliary arms.

In some embodiments, the landing gear is further provided with an antenna.

In some embodiments, a limiting structure is disposed at a joint of the arm and the vehicle body.

In some embodiments, the limiting structure includes a mounting member and an elastic component. The mounting member includes a main body portion and a rotating shaft. The rotating shaft connects the vehicle body and the main body portion, and the arm is sleeved on the rotating shaft. A surface of the main body portion facing the arm includes a first blocking portion, and a surface of the arm facing the main body portion includes a second blocking portion. The elastic component is sleeved on the rotating shaft. One end of the elastic component abuts against the arm, and the other end abuts against the vehicle body.

In some embodiments, the surface of the main body portion facing the arm is a helical surface.

In some embodiments, the surface of the main body portion facing the arm includes a helical surface and a rough plane connected to the helical surface.

In some embodiments, the rough plane includes a third blocking portion.

The embodiments of the present invention have beneficial effects as follows: The arm provided in the embodiments of the present invention can be in contact with the outline of the movable object after being folded, so that the structure of the movable object to which the arm is applied is more compact. When the arm is applied to the UAV, the arm is in contact with the outline of the vehicle body after being folded, so that the folding structure is simple, and the structure of the UAV is more compact after the arm is folded.

### BRIEF DESCRIPTION OF THE DRAWINGS

To describe the technical solutions in the embodiments of the present invention more clearly, the following briefly describes the accompanying drawings required for describing the embodiments of the present invention. Obviously, the accompanying drawings in the following descriptions are merely some embodiments of the present invention, and a person of ordinary skill in the art may further obtain other accompanying drawings according to the accompanying drawings without creative efforts.

FIG. 1 is a schematic three-dimensional structural diagram of an unmanned aerial vehicle (UAV) according to an embodiment of the present invention, where the UAV is in an unfolded state;

FIG. 2 is a schematic three-dimensional structural diagram of another angle of view of the UAV shown in FIG. 1;

FIG. 3 is a schematic three-dimensional structural diagram of the UAV shown in FIG. 1, where the UAV is in a folded state;

FIG. 4 is a bottom view of the UAV shown in FIG. 3;

FIG. 5 is a schematic diagram of a limiting structure according to an embodiment of the present invention;

FIG. 6 is a three-dimensional exploded diagram of the limiting structure shown in FIG. 3; and

FIG. 7 is a schematic structural diagram of a mounting member in the limiting structure shown in FIG. 3.

### DETAILED DESCRIPTION

For ease of understanding the present invention, the present invention is described in further detail below with reference to the accompanying drawings and specific implementations. It should be noted that when an element is described as being “fixed” on another element, the element may be directly on the another element, or one or more intermediate elements may exist therebetween. When an element is described as being “connected” to another element, the element may be directly connected to the another element, or one or more intermediate elements may exist therebetween. A direction or location relationship indicated by the term “perpendicular”, “horizontal”, “left”, “right”, “top”, “bottom”, or the like used in this specification is a direction or location relationship shown based on the accompanying drawings, and is only for ease of describing the present invention and simplifying the description, but is not intended to indicate or imply that a mentioned device or element needs to have a particular direction or is constructed and operated in the particular direction. Therefore, the direction or location relationship cannot be understood as a limitation to the present invention.

Unless otherwise defined, meanings of all technical and scientific terms used in this specification are the same as meanings usually understood by a person skilled in the technical field to which the present invention belongs. In this specification, terms used in the specification of the present invention are merely intended to describe objectives of the specific embodiments, but are not intended to limit the present invention. In addition, technical features in implementations of the present invention described below may be combined with each other provided that there is no conflict with each other. A term “and/or” used in this specification includes any or all combinations of one or more related listed items.

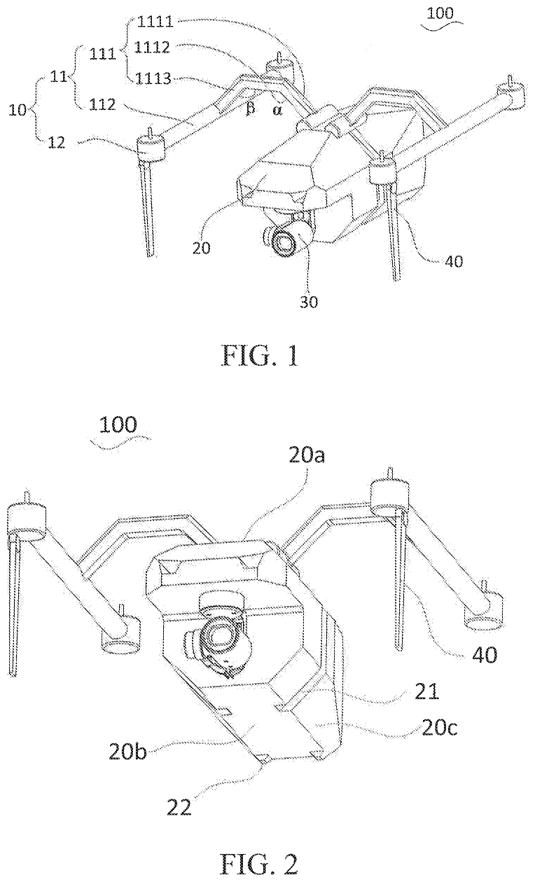

Referring to FIG. 1 to FIG. 4, an unmanned aerial vehicle (UAV) 100 includes a power component 10, a vehicle body 20, a camera device 30 and a landing gear 40. The power component 10 is mounted on the vehicle body 20 and is configured to provide power for the UAV 100, and drive the UAV 100 to fly and adjust a flight attitude. The vehicle body 20 generally includes a control circuit component including electronic devices such as an MCU. The control circuit component includes a plurality of control modules, such as a flight control module configured to control the flight attitude of the UAV, a Beidou module configured to navigate the UAV and a data processing module configured to process environmental information obtained by related airborne equipment (for example, the camera device 30). In addition, a rear end of the vehicle body 20 may be further provided with a battery compartment. The battery compartment is configured to accommodate batteries for supplying power to the control circuit component, and the batteries may be directly inserted into the battery compartment from the rear end of the vehicle body 20.

The camera device 30 is mounted at a front end of the vehicle body 20 and is configured to collect image information of a scene. The landing gear 40 is mounted to the power component 10 and is configured to make the UAV 100 smoothly stop on the ground or a plane when the UAV 100 lands, so as to play a supporting role. Certainly, it can be understood that in other embodiments, the camera device 30 and the landing gear 40 may alternatively be mounted in other suitable locations. For example, the camera device 30 is mounted at one side of the vehicle body 20 or below the vehicle body 20, the landing gear 40 is mounted below the vehicle body 20, and the like. This is not specifically limited in this embodiment of the present invention.

Specifically, in this embodiment, the power component 10 includes an arm 11 and a power device mounted on the arm 11. The power device includes a drive device 12 and a propeller (not shown) mounted on the drive device 12. Each drive device 12 drives the propeller corresponding to the drive device to rotate, so as to provide power for the UAV 100 and drive the UAV 100 to fly.

The arm 11 of the present invention is foldable relative to the vehicle body 20, and the arm 11 is in contact with an outline of the vehicle body 20 after being folded. That is, a shape of at least the portion facing the vehicle body 20 matches a shape of the outline of the vehicle body 20 after the arm 11 is folded, so that the UAV is more compact in structure and easier to carry. Furthermore, it can be understood that in actual application, the application field of the arm 11 provided by the embodiments of the present invention should not be limited to only the field of UAV technologies. The arm 11 may alternatively be mounted to other types of movable objects, such as an unmanned surface vehicle, an unmanned submarine, a robot. The arm 11 is in contact with an outline of the movable object after being folded, so that the structure of the movable object to which the arm 11 is applied is more compact.

In an embodiment, the arm 11 includes a main arm 111 and an auxiliary arm 112. One end of the main arm 111 is mounted on the vehicle body 20, and the other end is connected to the auxiliary arm 112. Both the power device and the landing gear 40 are mounted on an end portion of the auxiliary arm. The main arm 111 may rotate relative to the vehicle body 20, and when the main arm 111 rotates relative to the vehicle body 20, the auxiliary arm 112 may also rotate relative to the vehicle body 20 under the drive of the main arm 111. After the arm 11 is folded, the main arm 111 and the auxiliary arm 112 are in close contact with the vehicle body 20. In this embodiment, by setting the main arm 111 to rotate relative to the vehicle body 20, the main arm 11 can be folded. The folding structure is simple and easy to use. In addition, by properly designing, for example, making surfaces of the main arm 111 and the auxiliary arm 112 facing the vehicle body 20 match the outline of the vehicle body 20, the arm 11 can be in contact with the outline of the vehicle body 20 after being folded, so that the structure of the UAV 100 is more compact after the arm 11 is folded.

In this embodiment, the main arm 111 includes a first connecting rod 1111 hinged to the vehicle body 20, a second connecting rod 1112 connected to the first connecting rod 1111 and a third connecting rod 1113 connected to the second connecting rod 1112. A middle portion of the auxiliary arm 112 is connected to a tail end of the third connecting rod 1113. The middle portion of the auxiliary arm 112 refers to a middle position in a length direction of the auxiliary arm 112. In this embodiment, the middle portion of the auxiliary arm 112 is connected to the tail end of the third connecting rod 1113. When rotating relative to the vehicle body 20, the first connecting rod 1111 drives the second connecting rod 1112, the third connecting rod 1113 and the auxiliary arm 112 to rotate relative to the vehicle body 20. In addition, in this embodiment, an included angle α between the first connecting rod 1111 and the second connecting rod 1112 is an obtuse angle, and an included angle β between the second connecting rod 1112 and the third connecting rod 1113 is also an obtuse angle, so that the first connecting rod 1111, the second connecting rod 1112 and the third connecting rod 1113 form an arc-shaped structure. When the UAV 100 is in flight, the arc-shaped structure can enhance the strength of the arm 11, so that the arm 11 can bear a larger pulling force.

The second connecting rod 1112 and the first connecting rod 1111 may be fixedly connected or hinged. When the second connecting rod 1112 is hinged to the other end of the first connecting rod 1111, an angle between the first connecting rod 1111 and the second connecting rod 1112 may be adjusted according to the shape of the vehicle body 20 when the arm 11 is folded, so that the folded structure is more compact. Similarly, in this embodiment, the third connecting rod 1113 and the second connecting rod 1112 as well as the auxiliary arm 112 and the tail end of the third connecting rod 1113 may also be fixedly connected or hinged. When the third connecting rod 1113 is hinged to the second connecting rod 1112 and/or the auxiliary arm 112 is hinged to the tail end of the third connecting rod 1113, an angle between the second connecting rod 1112 and the third connecting rod 1113 and/or an angle between the third connecting rod 1113 and the auxiliary arm 112 may be adjusted according to the shape of the vehicle body 20 when the arm 11 is folded, so that the folded structure is more compact.

Referring to FIG. 2, the vehicle body 20 in this embodiment includes a first surface 20a and a second surface 20b opposite to the first surface 20a. The main arm 111 is hinged to the first surface 20a, that is, the main arm 111 is rotatably mounted on the first surface 20a. After the arm 11 is folded, the first connecting rod 1111, the second connecting rod 1112 and the third connecting rod 1113 are in close contact with a vehicle body side 20c between the first surface 20a and the second surface 20b respectively, and the auxiliary arm 112 is in close contact with the second surface 20b. In addition, to further ensure that the arm 11 is in more contact with the outline of the vehicle body 20 after the arm 11 is folded, a position in which the vehicle body 20 corresponds to the arm 11 is further provided with an accommodating groove 21, and the arm 11 is accommodated in the accommodating groove 21 after being folded.

It can be understood that the structure of the arm 11 is not limited to the structure described above, as long as the arm 11 is in contact with the outline of the vehicle body 20 after being folded. For example, if the outline of the vehicle body 20 is an elliptical surface, a shape of the arm 11 may be changed to an arc shape that matches the elliptical surface. For another example, the arm 11 may be a flexible member having certain strength, and when the arm is folded, the shape of the arm 11 may be changed according to the outline of the vehicle body 20, so that the arm 11 is in contact with the outline of the vehicle body 20 after being folded. In addition, after being unfolded, the arm can support the drive device 12 to complete the flight of the UAV 100 because the arm has certain strength.

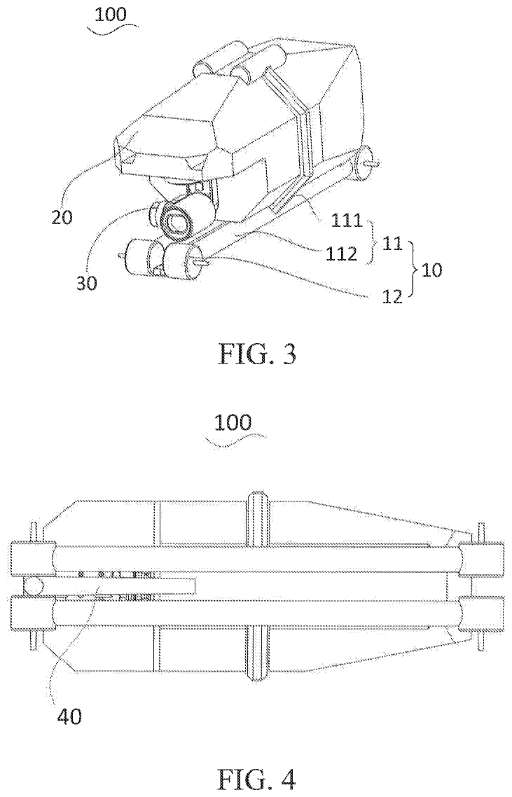

In this embodiment, the UAV 100 includes two arms 11, where one end of one arm 11 is mounted at one side of the vehicle body 20, one end of the other arm 111 is mounted at an opposite side of the vehicle body 20, and both arms 111 may rotate upward or downward relative to the vehicle body 20. The other end of each main arm 111 is connected to the middle portion of its corresponding auxiliary arm 112, and two ends of each auxiliary arm 112 are configured to mount the drive device 12, so that a distance from each drive device 12 to the main arm 111 may be equal, so as to implement different flight attitudes by directly adjusting the rotating speed of each drive device 12. When the two main arms 111 rotate upward relative to the vehicle body 20, both the two main arms 111 and the two auxiliary arms 112 are gradually away from the vehicle body 20. When the two main arms 111 rotate upward to a preset angle, as shown in FIG. 1, the drive devices 12 disposed at the two ends of each auxiliary arm 112 are located on the same plane, and the two arms 11 are in an unfolded state. When the two main arms 111 rotate downward relative to the vehicle body 20, both the two main arms 111 and the two auxiliary arms 112 are gradually close to the vehicle body 20 until the two main arms 111 are in close contact with two opposite sides of the vehicle body 20 respectively, and the two auxiliary arms 112 are in close contact with a lower surface of the vehicle body 20. As shown in FIG. 3, the two arms 11 are in a folded state.

Referring to FIG. 3 and FIG. 4, in this embodiment, after the two arms 11 are folded the power devices located on the auxiliary arms 112 respectively are disposed in directions away from each other. That is, after the two arms 11 are folded, ends, mounted with the propeller, of the power devices are disposed away from each other.

In addition, in this embodiment, the auxiliary arm 112 is further provided with a landing gear 40. To make full use of the space of the UAV 100, an antenna for implementing communication connection of the UAV 100 and other devices may be further provided in the landing gear 40. The antenna may be or may include a compass, a WIFI communications antenna, an LTE antenna, a GPS receiver, or the like. To make the folded overall structure of the UAV 100 more compact, the landing gear 40 is hinged to the auxiliary arm 112, and the landing gear 40 can rotate relative to the auxiliary arm 112 under an external force. There is a specific distance between the two auxiliary arms 112 after the two arms 11 are folded, and the landing gear 40 is folded and received between the two auxiliary arms 112.

During the folding of the UAV 100, the two landing gears 40 may first be rotated in a direction close to the main arm 111, so that the two landing gears 40 are parallel to their corresponding auxiliary arms 112. Then, the main arm 111 is rotated, so that the main arm 111 drives the auxiliary arm 112, the drive device 12, and the landing gear 40 to rotate downward relative to the vehicle body 20 until the main arm 111 is in close contact with the vehicle body side 20c, and the auxiliary arm 112 is in close contact with the second surface 20b. In this case, the two landing gears 40 are folded and received between the two auxiliary arms 112, so that after the entire UAV 100 is folded, the structure becomes very compact and easy to carry, and the folding structure is simple and easy to use.

During the unfolding of the UAV 100, the main arm 111 may first be rotated, so that the main arm 111 drives the auxiliary arm 112, the drive device 12 and the landing gear 40 to rotate upward relative to the vehicle body 20 until one end of the main arm 111 abuts against the limiting structure at the joint of the main arm 111 and the vehicle body 20. Then, the landing gear 40 is rotated, so that an included angle between the landing gear 40 and the auxiliary arm 112 is 90° C.

Certainly, it can be understood that in other embodiments, the UAV 100 may alternatively include four landing gears 40. Two landing gears 40 are mounted at two ends of one of the auxiliary arms 112, and the other two landing gears 40 are mounted at two ends of the other auxiliary arm 112. In this embodiment, the four landing gears 40 provide stable support for the UAV 100, so as to prevent the vehicle body 20 from being in contact with a support surface and reduce the wear of the vehicle body 20.

Still referring to FIG. 2, in this embodiment, one end of the vehicle body 20 is provided with a rubber pad 22. The rubber pad 22 may be disposed at the bottom of one end of the vehicle body 20 (as shown in FIG. 2) or may be disposed at one side of one end of the vehicle body, so as to provide support for the UAV 100. A quantity of the rubber pads 22 may be 1, 2, 3, 5, or the like. This is not specifically limited in this embodiment. When the UAV 100 is in an unfolded state, the two landing gears 40 and the rubber pad 22 form stable support, which jointly provide a stable take-off/landing platform for the UAV 100. When the UAV 100 is in a folded state, the landing gear 40 rotates in a direction close to the main arm 111 until the landing gear is parallel to the auxiliary arm 112. In this embodiment, the quantity of the landing gears 40 can be reduced by providing stable support for the UAV 100 by the two landing gears 40 and the rubber pad 22, so that the structure of the UAV 100 is more compact and easy to carry.

It can be understood that in this embodiment, an example in which the power device 10 includes two arms 11 is used for describing the embodiments of the present invention. However, in other embodiments, the power device 10 may alternatively include more or fewer arms 11.

It can be understood that in this embodiment, each arm 11 includes a main arm 111 and an auxiliary arm 112. In other embodiments, each arm 11 may alternatively include more main arms 111 and/or auxiliary arms 112.

For example, in some embodiments, each arm 11 may include at least two main arms 111 and one auxiliary arm 112. The at least two main arms 111 are disposed in parallel to one side of the vehicle body 20 and connected to the auxiliary arm 112. Generally, when the UAV 100 needs to adjust the flight attitude, the UAV needs to adjust the rotating speed of the drive devices 12 at two ends of the auxiliary arm 112 to generate different pulling forces. However, when the pulling forces generated by the drive devices 12 at the two ends of the auxiliary arm 112 are different, a torsional force is generated to the main arm 111. Under the torsional force, the main arm 111 easily generates an elastic deformation. Therefore, on one hand, the UAV 100 cannot fly in a preset flight attitude in time and accurately, affecting the control precision of the UAV 100. On the other hand, the service life of the arm 11 is easily shortened due to the fact that the main arm 111 is subjected to the torsional force for a long time. However, in this embodiment, the arm 11 includes at least two main arms 111, so as to reduce the torsion force borne by each main arm 111 when the UAV 100 adjusts the flight attitude, and reduce the elastic deformation of the main arm 111, thereby improving the control precision of the UAV 100 is improved and prolong the service life of the arm 11.

In this embodiment, to improve the stability of the arm 11 when the UAV 100 is in flight, a limiting structure is provided at the joint between the arm 11 and the vehicle body 20 and is configured to limit an included angle between the arm 11 and the vehicle body 20 to a preset angle when the UAV 100 is in flight, so as to avoid that the arm 11 rotates downward relative to the vehicle body 20 due to its own gravity, or rotates upward relative to the vehicle body 20 due to the pulling force generated by the rotation of the propeller, affecting the normal flight of the UAV 100. The limiting structure may be any suitable limiting component, such as a spring lock, or may be a control device that may adjust the included angle between the arm 11 and the vehicle body 20 in real time. The control device includes a drive unit. By controlling the drive unit, the arm 11 may be controlled to rotate relative to the vehicle body 20, and the included angle between the arm 11 and the vehicle body 20 may be fixed to a preset angle according to the use state.

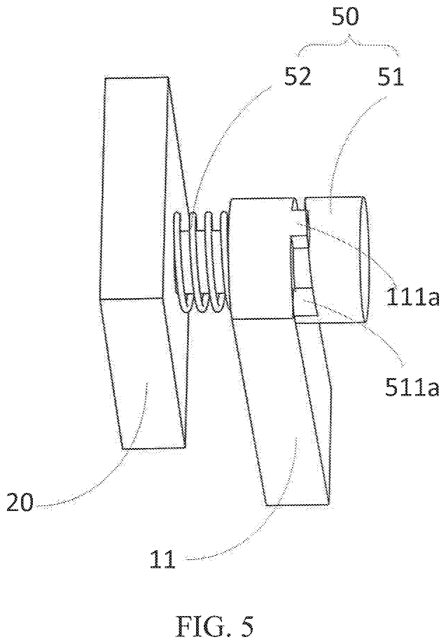

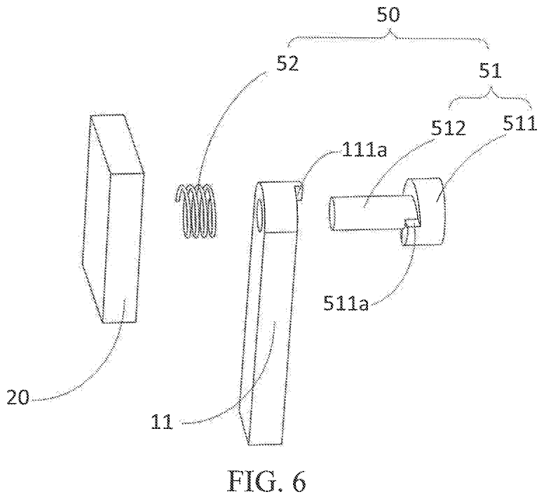

Specifically, to reduce the weight of the UAV 100 and the production costs, the limiting structure may further be a limiting structure 50 shown in FIG. 5 or FIG. 6. The limiting structure 50 is disposed at the joint of the vehicle body 20 and the arm 11 and includes a mounting member 51 and an elastic component 52. The mounting member 51 includes a main body portion 511 and a rotating shaft 512. The rotating shaft 512 connects the vehicle body 20 and the main body portion 511, and the arm 11 is sleeved on the rotating shaft 512. A surface of the main body portion 511 facing the arm 11 includes a first blocking portion 511a, and a surface of the arm 11 facing the main body portion 511 includes a second blocking portion 111a. The elastic component 52 is sleeved on the rotating shaft 512. One end of the elastic component 52 abuts against the arm 11, and the other end abuts against the vehicle body 20.

Therefore, when a user is unfolding the arm 11, the arm 11 rotates upward relative to the vehicle body 20 due to an upward external force until the second blocking portion 111a of the arm 11 abuts against the first blocking portion 511a. In the unfolded state of the arm 11, on one hand, the arm 11 overcomes its own gravity due to a friction between the arm and the main body portion 511, so that the arm does not rotate downward relative to the vehicle body 20; on the other hand, when the drive device 12 drives the propeller to rotate to generate an upward pulling force to the arm 11, the arm 11 counteracts the pulling force due to the downward pressure of the first blocking portion 511a, so that the arm does not rotate upward relative to the vehicle body 20. When the user is folding the arm 11, the second blocking portion 111a of the arm 11 rotates downward relative to the vehicle body 20 (that is, rotates in a direction away from the first blocking portion 5111a) along the surface of the main body portion 5111 facing the arm 11 due to a downward external force until the arm 11 is in contact with the outline of the vehicle body 20.

Specifically, in some embodiments, the surface of the main body portion 5111 facing the arm 11 is a helical surface. Two edges of the helical surface form a height difference in a direction perpendicular to an axial direction of the rotating shaft 512. A blocking wall formed by the height difference constitutes the first blocking portion 511a. In this embodiment, because the surface of the main body portion 511 facing the arm 11 is the helical surface, when the second blocking portion 111a rotates in the direction away from the first blocking portion 5111a, the arm 11 is gradually close to the vehicle body 20 in the direction perpendicular to the axial direction of the rotating shaft 512 and presses the elastic component 52. Therefore, under the counterforce of the elastic component 52, the friction between the arm 11 and the main body portion 511 is gradually increased, so that the arm 11 does not shake freely after being folded, and the structure of the folded UAV 100 is more compact.

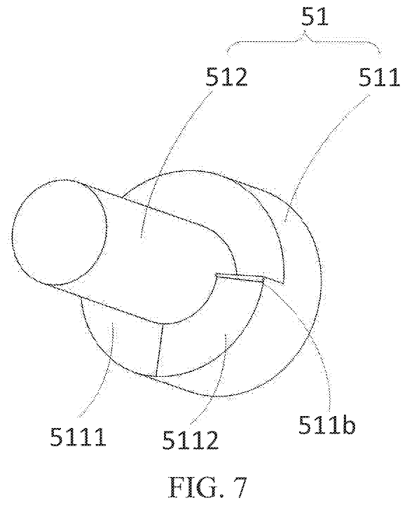

Alternatively, in other embodiments, as shown in FIG. 7, the surface of the main body portion 511 facing the arm 11 includes a helical surface 5111 and a rough plane 5112. An edge of the helical surface 5111 is connected to an edge of the rough plane 5112, and the other edge of the helical surface 5111 and the other edge of the rough plane 5112 form a height difference in the axial direction of the rotating shaft 512. A blocking wall formed by the height difference constitutes the first blocking portion 511a. In this embodiment, by setting the surface of the main body portion 511 facing the arm 11 as a combination of the helical surface 5111 and the rough plane 5112, the friction between the arm 11 and the main body portion 511 after the arm 11 is folded can be further increased, and the compactness of the structure after the arm 11 is folded can be improved. In addition, when sliding the second blocking portion 111a (the arm 11) from the rough plane 5112 to the helical surface 5111 to unfold the arm 11, the user may stop applying a force to the arm 11, and the arm 11 can be rotated to the unfolded state (that is, the second blocking portion 111a abuts against the first blocking portion 511a) only under the effect of residual forces.

In addition, to avoid the sliding rail of the second blocking portion 111a caused by that a rotated angle of the arm 11 is excessively large when the user is folding the arm 11, a third blocking portion 511b may be further provided on the rough plane 5112.

It should be noted that exemplary embodiments of the present invention are given in the specification of the present invention and in the accompanying drawings. However, the present invention may be implemented in many different forms and is not limited to the embodiments described in this specification. These embodiments are not intended as additional limitations to the content of the present invention. An objective of providing the embodiments is to better clearly and comprehensively understand the content disclosure in the present invention. In addition, the technical features continue to be combined with each other to form the embodiments not listed above, which are all intended to be the scope recorded in this specification of the present invention. Further, a person of ordinary skill in the art may make modifications and alterations according to the foregoing descriptions, and all these modifications and alterations are intended to fall within the protection scope of the appended claims of the present invention.

What is claimed is:

1. An arm mounted on a movable object, wherein the arm is in contact with an outline of the movable object after being folded.

2. The arm according to claim 1, wherein the arm comprises a main arm and an auxiliary arm connected to the main arm.

3. The arm according to claim 2, wherein the main arm comprises at least two connecting rods, one end of at least one of the at least two connecting rods being connected to the auxiliary arm.

4. The arm according to claim 3, wherein the main arm comprises a first connecting rod and a third connecting rod connected to one end of the first connecting rod, and the auxiliary arm is connected to a tail end of the third connecting rod.

5. The arm according to claim 4, wherein the main arm further comprises a second connecting rod, one end of the second connecting rod being connected to one end of the first connecting rod, and the other end being connected to one end of the third connecting rod.

6. The arm according to claim 5, wherein the second connecting rod is hinged to one end of the first connecting rod.

7. The arm according to claim 5, wherein the third connecting rod is hinged to the second connecting rod.

8. The arm according to claim 5, wherein an included angle α between the first connecting rod and the second connecting rod is an obtuse angle, and an included angle β between the second connecting rod and the third connecting rod is an obtuse angle.

9. The arm according to claim 4, wherein the auxiliary arm is hinged to the tail end of the third connecting rod.

10. The arm according to claim 9, wherein a middle portion of the auxiliary arm is hinged to the tail end of the third connecting rod.

11. The arm according to claim 1, wherein the arm is a flexible member having certain strength, and a shape of the flexible member is changeable according to the outline of the movable object, so that the arm is in contact with the outline of the movable object after being folded.

12. An unmanned aerial vehicle (UAV), comprising a vehicle body, an arm connected to the vehicle body and a power device disposed on the arm, wherein the arm is in contact with an outline of the vehicle body after being folded.

13. The UAV according to claim 12, wherein the arm is the arm according to any of claims 1 to 11.

14. The UAV according to claim 12, wherein the vehicle body is provided with an accommodating groove corresponding to the arm, and the arm is accommodated in the accommodating groove after being folded.

15. The UAV according to claim 12, wherein there are at least two arms, each arm comprises a main arm and an auxiliary arm connected to the main arm, the power device is disposed on the auxiliary arm, and after the two arms are folded the power devices located on the two auxiliary arms respectively are disposed in directions away from each other.

16. The UAV according to claim 15, wherein the auxiliary arm is further provided with a landing gear.

17. The UAV according to claim 16, wherein the landing gear is hinged to the auxiliary arm, there is a certain distance between the at least two auxiliary arms after the at least two arms are folded, and the landing gear is folded and received between the at least two auxiliary arms.

18. The UAV according to claim 16, wherein the landing gear is further provided with an antenna.

19. The UAV according to claim 12, wherein a limiting structure is disposed at a joint of the arm and the vehicle body.

20. The UAV according to claim 19, wherein the limiting structure comprises a mounting member and an elastic component, wherein
the mounting member comprises a main body portion and a rotating shaft, the rotating shaft connects the vehicle body and the main body portion, the arm is sleeved on the rotating shaft, a surface of the main body portion facing the arm comprises a first blocking portion, a surface of the arm facing the main body portion comprises a second blocking portion, the elastic component is sleeved on the rotating shaft, one end of the elastic component abuts against the arm, and the other end abuts against the vehicle body.
